(19) United States
(12) Patent Application Publication
(10) Pub. No.: US 2010/0084246 A1
(43) Pub. Date: Apr. 8, 2010

(54) ITEM TRANSPORT SYSTEM WITH AIR DIVERT MODULE

(75) Inventors: W. Scott Kalm, Sarasota, FL (US); Eric T. Schamell, St. Petersburg, FL (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 12/334,840

(22) Filed: Dec. 15, 2008

Related U.S. Application Data
(60) Provisional application No. 61/102,995, filed on Oct. 6, 2008.

(51) Int. Cl. B65G 47/46; B65G 47/00

(52) U.S. Cl. 198/617; 198/370.11; 198/370.12

(57) ABSTRACT

An item transport system includes a first transport and a divert module for diverting predetermined items. The first transport includes a first deck for supporting items and a first transport element for transporting the items along the first deck on a transport path. The divert module includes a second deck for supporting the predetermined items, a second transport element for transporting the predetermined items along the second deck on a divert path, and a fluid supply element selectively actuable to direct a fluid onto at least a leading edge of the predetermined items to divert the predetermined items onto the second deck.

### CROSS REFERENCE TO RELATED APPLICATIONS

The benefit of priority is claimed under 35 U.S.C. 119(e) of U.S. Provisional Patent Application No. 61/102,995, filed Oct. 6, 2008, entitled “Air Divert Module,” which is incorporated by reference herein in its entirety.

### FIELD OF THE INVENTION

The present invention relates to a system for transporting items and, more particularly, to an item transport system with an air divert module.

### BACKGROUND OF THE INVENTION

Item transport systems, such as mailpiece handling systems, for example, are known in the art. These systems include inserter systems, which create mailpieces and prepare them for mailing, as well as sortation systems, which sort completed mailpieces and direct the mailpieces to storage pockets or bins, depending on the system's configuration. Other types of transport systems and related applications are known.

In some mailpiece handling systems, mailpieces are transported using belts or chain drives between stations where they undergo various types of processing. The processing may include cutting, folding, scanning, weighing, printing, and labeling, for example.

Mailpieces are frequently diverted between different travel paths while being processed in mailpiece handling systems. In one example, where a system fails to properly carry out one of the above-identified processing steps, a mailpiece may be diverted out of the processing path. The diverted mailpiece in that case may be rejected as being defective or may be reentered in the system for repeat processing.

In another example, a mailpiece may be diverted as part of its normal processing in the mailpiece handling system. In sortation systems, for example, mailpieces are sequentially fed in for processing and are subsequently diverted through a variety of travel paths and ultimately diverted into a sortation bin or pocket.

Important design considerations for a diverter mechanism are speed and reliability. As the throughput speeds of mailpiece processing systems increase, it is necessary for diverter mechanisms to reliably process mailpieces at higher rates.

### SUMMARY OF EXEMPLARY ASPECTS

In the following description, certain aspects and embodiments of the present invention will become evident. It should be understood that the invention, in its broadest sense, could be practiced without having one or more features of these aspects and embodiments. It should also be understood that these aspects and embodiments are merely exemplary.

In accordance with the purpose of the invention, as embodied and broadly described herein, one aspect of the invention relates to an item transport system comprising a first transport and a divert module for diverting predetermined items. The transport system may comprise a first deck for supporting items and a first transport element for transporting the items along the first deck on a transport path. The divert module may comprise a second deck for supporting the predetermined items, a second transport element for transporting the predetermined items along the second deck on a divert path, and a fluid supply element selectively actuable to direct a fluid onto at least a leading edge of the predetermined items to divert the predetermined items onto the second deck.

As used herein, “items” include papers, documents, postcards, envelopes, brochures, enclosures, booklets, magazines, media items, including CDs, DVDs, computer disks, and/or other digital storage media, and packages having a range of sizes and materials.

In another aspect, the invention relates to a method of transporting items comprising transporting the items on a first transport and diverting predetermined items on a divert module. Transporting the items on a first transport may comprise supporting the items on a first deck and transporting the items with a first transport element along the first deck on a transport path. Diverting predetermined items on a divert module may comprise selectively actuating a fluid supply element to direct a fluid onto at least a leading edge of the predetermined items to divert the predetermined items onto a second deck, supporting the predetermined items on the second deck, and transporting the predetermined items with a second transport element along the second deck on a divert path.

In a further aspect, the invention provides an item transport system comprising a first transport and a divert module for diverting predetermined items. The first transport may comprise a first deck for supporting items, a first transport element for transporting the items along the first deck on a transport path, and a plurality of first support elements rotatably supporting the first transport element. The divert module for diverting predetermined items may comprise a second deck for supporting the predetermined items, a second transport element for transporting the predetermined items along the second deck on a divert path, a plurality of second support elements rotatably supporting the second transport element, and a fluid supply element selectively actuable to direct a fluid onto at least a leading edge of the predetermined items to divert the predetermined items onto the second deck. The item transport system may also comprise a drive element for driving at least one of the first support elements and at least one of the second support elements.

Aside from the structural and procedural arrangements set forth above, the invention could include a number of other arrangements, such as those explained hereinafter. It is to be understood that both the foregoing description and the following description are exemplary only.

### BRIEF DESCRIPTION OF THE DRAWINGS

The accompanying drawings, which are incorporated in and constitute a part of this specification, illustrate exemplary embodiments of the invention and, together with the description, serve to explain the principles of the invention. In the drawings,

FIG. 1 is a schematic view of an inserter system utilizing an embodiment of the item transport system of the present invention;

FIG. 2 is a partial side view of the item transport system of the present invention;

FIG. 3 is a partial perspective view of the item transport system of FIG. 2;

FIG. 4 is a perspective view of a portion of the divert module;

FIG. 5 is a schematic view of the item transport system of the present invention transporting an item on the transport path; and

FIG. 6 is a schematic view of the item transport system of the present invention transporting an item on the divert path.

### DETAILED DESCRIPTION OF EXEMPLARY EMBODIMENTS

Reference will now be made in detail to exemplary embodiments of the invention, examples of which are illustrated in the accompanying drawings. Wherever possible, the same reference numbers will be used throughout the drawings to refer to the same or like parts.

Embodiments of the item transport system according the invention will be described with reference to certain applications in mailpiece inserter systems. It should be understood, however, that the device of the invention may be used in association with other systems configured to handle and transport items.

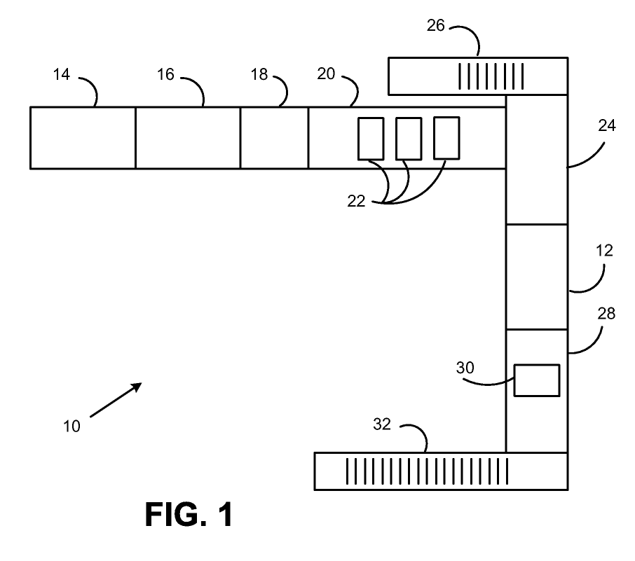

A schematic view of an inserter system 10 incorporating the item transport system 12 of the invention is shown in FIG. 1. The illustrated exemplary inserter system 10 comprises a sheet feeder 14, which provides pre-printed documents for processing. The documents, which may comprise bills or financial statements, for example, may be provided by the sheet feeder 14 as individual “cut sheets,” or may be cut from a spool using a web cutter (not shown).

The documents next move to an accumulator 16, where the documents for respective mailpieces are assembled and folded. The folded accumulations next move to a buffer 18, which holds the accumulations for sequential processing. The accumulations next move to a chassis 20. As each accumulation moves through the chassis, inserts from a plurality of feeder modules 22 are added to the accumulation.

The accumulations next enter an insertion area 24, where the finished accumulations are stuffed into envelopes provided by an envelope hopper 26, and the envelopes are sealed. The stuffed, sealed envelopes next pass through the item transport system 12 of the invention, as discussed in more detail below.

The envelopes then enter a printing area 28, where markings, such as a postage indicia and/or address information, for example, are applied using a printer 30. Finally, the completed mailpieces are deposited on a conveyor 32.

Although the item transport system 12 of the present invention is shown as an individual component in FIG. 1, features of the invention may be incorporated into other components in the illustrated inserter system 10, as well as into other systems configured to handle and transport items.

The item transport system 12 may be incorporated into mailpiece handling systems to reliably divert items at high speeds. Embodiments of the device of the invention have been successfully implemented in mailpiece handling systems configured to process 30,000 mailpieces per hour.

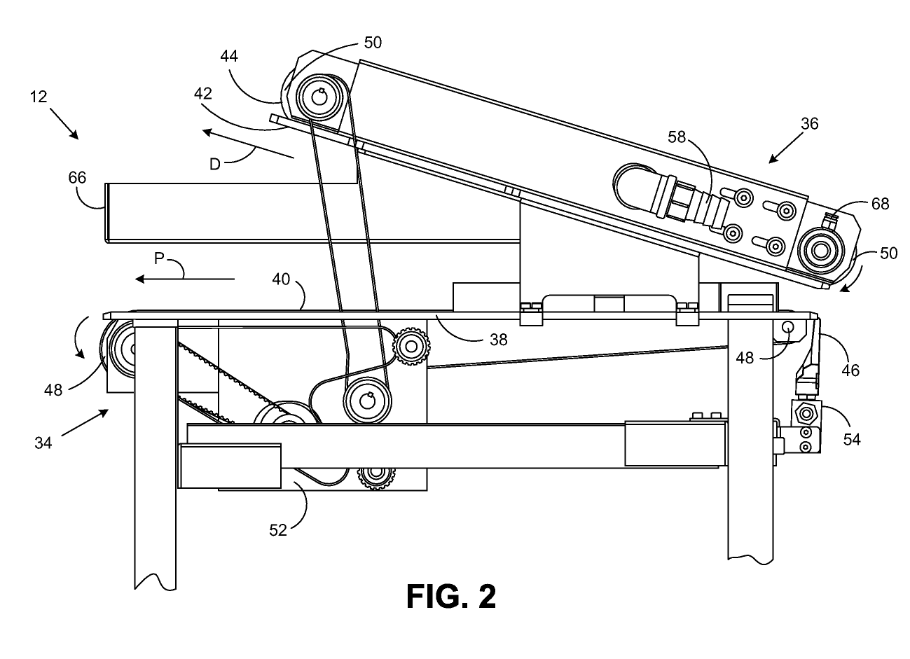

An embodiment of the item transport system 12 of the invention is shown in FIG. 2. The transport system 12 in the illustrated embodiment comprises a first transport 34 and a divert module 36 for diverting predetermined items.

In the illustrated embodiment, the first transport 34 comprises a first deck 38 for supporting items and a first transport element 40 for transporting the items along the first deck 38 on a transport path P. The divert module 36 comprises a second deck 42 for supporting the predetermined items, a second transport element 44 for transporting the predetermined items along the second deck 42 on a divert path D, and a fluid supply element 46 selectively actuable to direct a fluid onto at least a leading edge of the predetermined items to divert the predetermined items onto the second deck 42. As shown in FIG. 2, the second deck 42 is disposed above the first deck 38. Other arrangements may also be used.

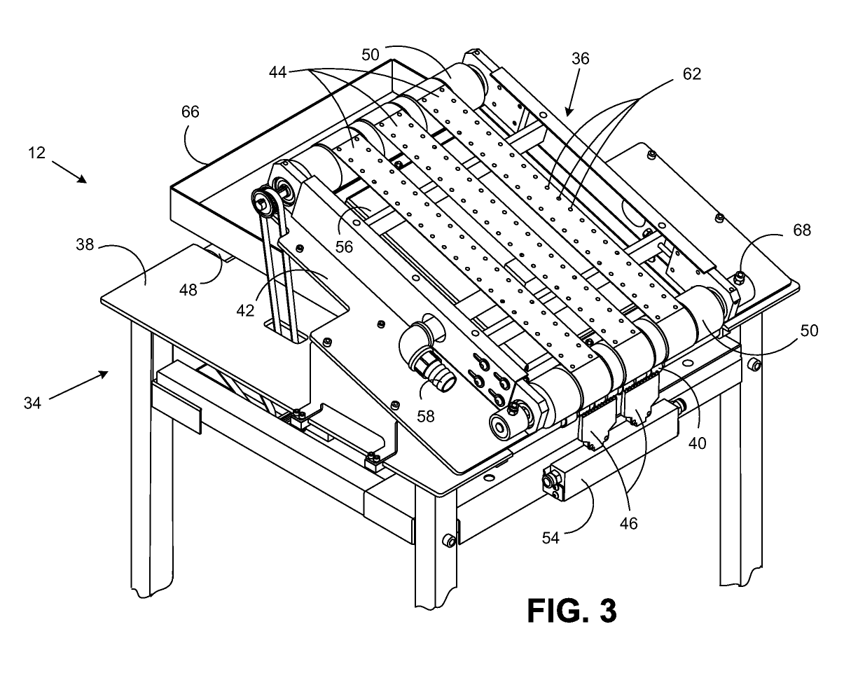

The first transport element 40 and the second transport element 44 shown in FIGS. 2 and 3 comprise smooth, elastic belts. In further embodiments, the first transport element 40 and the second transport element 44 may comprise O-rings, toothed belts, or other drive elements. In addition, the item transport system 12 shown in FIGS. 2 and 3 comprises four first transport elements 40 and three second transport elements 44. Transports having more or fewer transport elements may also be used.

The item transport system 12 shown in FIGS. 2 and 3 further comprises a plurality of first support elements 48 rotatably supporting the first transport elements 40, a plurality of second support elements 50 rotatably supporting the second transport elements 44, and a drive element 52 for driving at least one of the first support elements 48 and at least one of the second support elements 50. The transport elements 40, 44 are driven in the directions indicated by the arrows shown in FIG. 2.

The support elements 48, 50 in the illustrated embodiment comprise smooth rollers. Other types of support elements may also be used, depending on the type of transport elements used. In addition, two first support elements 48 and two second support elements 50 are shown, but drive arrangements utilizing other numbers of support elements may also be used. In the illustrated embodiment, a drive element 52 comprising a single AC motor is used to drive one of the first support elements 48 and one of the second support elements 50. Multiple drive elements, each driving a single support element, may also be used. Control of the drive element 52 and of the actuation of the fluid supply element 46 are provided using a programmable logic controller (not shown).

As shown in FIG. 2, the fluid supply element 46 is disposed upstream of the first transport 34. Further, a leading edge of the second deck 42 is disposed upstream of the fluid supply element 46. In one embodiment, the fluid discharged by the fluid supply element 46 comprises air. Air may be provided from an air source, such as a compressor, for example, to an air manifold 54, shown in FIGS. 2 and 3.

In some embodiments, the fluid supply element 46 comprises a nozzle for directing the fluid. Various arrangements of fluid supply elements have been used. In one arrangement, the fluid supply element 46 comprises a plurality of nozzles arranged in a direction substantially perpendicular to the divert path D. In the embodiment shown in FIG. 3, two nozzles having a substantially rectangular cross-section are utilized. In the illustrated embodiment, the nozzles are disposed just below a top surface of the first deck 38. Other arrangements may also be used.

The fluid supply element 46 is configured to provide a burst of air onto at least the leading edge of the predetermined items received by the item transport system 12. The burst of air provides an essentially instantaneous force on the leading edge of the predetermined items to divert the items onto the second deck 42. The timing and duration of the bursts may be adjusted based on the processing speed of the system and the size and shape of the items being processed.

In one example, a fluid supply element 46 comprising three zinc nozzles, each having a substantially rectangular opening approximately 1/32 inches wide and approximately 2 inches long, was used. In another example, a fluid supply element 46 comprising two stainless steel nozzles, each having a substantially rectangular opening approximately 1/16 inches wide and approximately two inches long, was used. Different numbers of fluid supply elements may also be used. In addition, fluid supply elements comprising other materials and having different sizes and shapes may also be used.

In a further example, air was provided to the fluid supply element 46 at approximately 40 pounds per square inch. In that example, a facility air supply (e.g., a compressor) was used as the fluid source. The air was passed through a filter, then directed to a regulator for maintaining the air at a substantially constant pressure. From the regulator, the air was provided to the nozzles. Other fluid supply arrangements may also be used.

As shown in FIG. 3, the divert module 36 further comprises a vacuum plenum 56 proximate to the second deck 42. A vacuum line (not shown) connects to a port 58 on the side of the divert module 36 to provide negative pressure to the vacuum plenum 56.

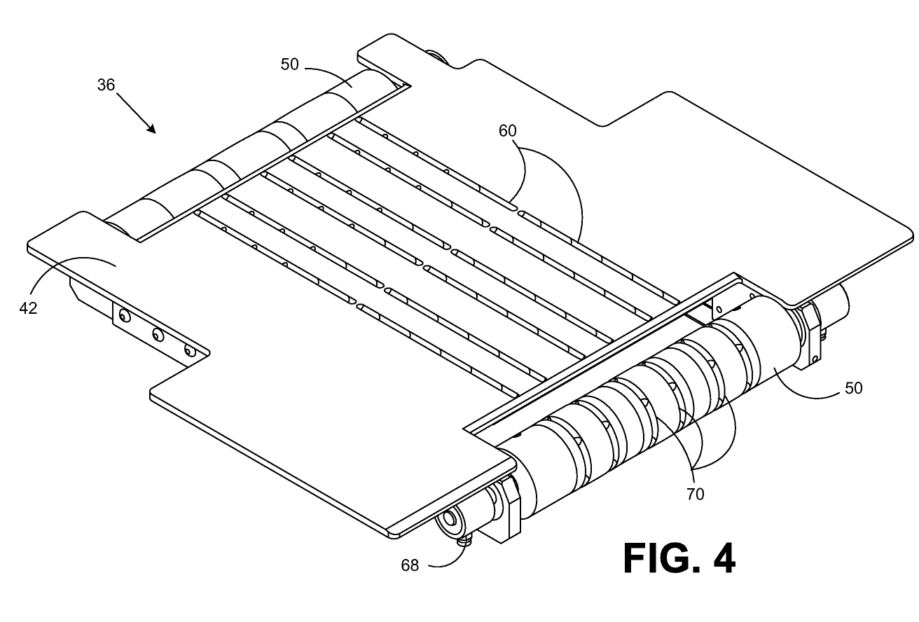

FIG. 4 shows the underside of the divert module 36 in which the second deck 42 is visible. The opening 60 in the second deck 42, shown in FIG. 4, is in fluid communication with the vacuum plenum 56. In the illustrated embodiment, the opening 60 comprises multiple openings extending over essentially the entire length of the second deck 42. Other numbers and arrangements of openings may also be used.

As shown in FIG. 3, there are a plurality of orifices 62 in the second transport element 44. In the illustrated embodiment, the orifices 62 in the second transport element 44 are substantially aligned with the openings 60 in the second deck 42. Thus, each orifice 62 is in fluid communication with an opening 60 when adjacent to the opening.

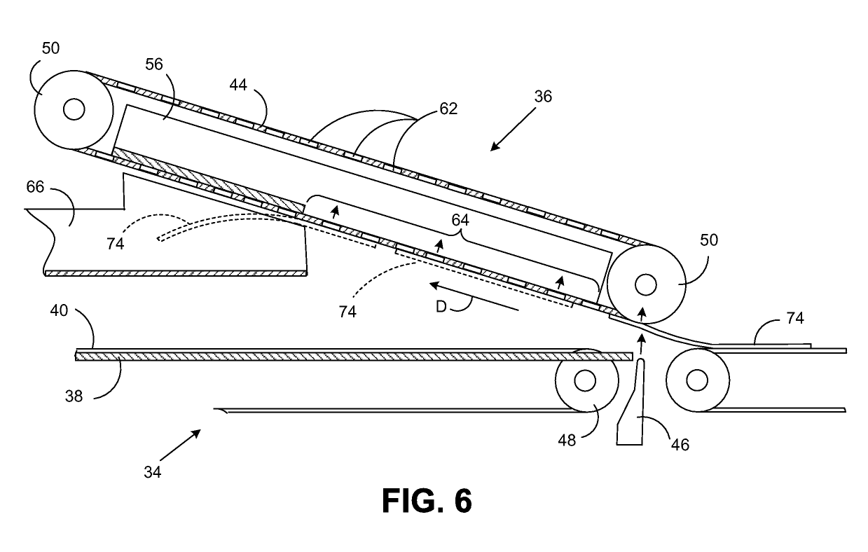

The openings 60 may be selectively blocked to define a suction region 64 extending over a portion of the second deck 42, as shown in FIG. 6. As shown in FIGS. 2, 3, and 6, the item transport system 12 further comprises a receptacle 66 disposed at a downstream end of the suction region 64 for receiving the predetermined items from the second transport element 44. The length of the suction region 64 may be varied to accommodate items of different size. For example, longer items may require a longer suction region 64 in order to fully pass into the divert module 36.

In the illustrated embodiment of the divert module 36, the second support element 50 at the leading edge of the second deck 42 comprises an internal chamber that may be connected to a vacuum source through a port 68, shown in FIGS. 2-4. The second support element 50 further comprises a plurality of channels 70 in fluid communication with the internal chamber, as shown in FIG. 4. The plurality of channels 70 are substantially aligned with the openings 60 in the second deck 42. In addition, the orifices 62 in the second transport element 44 are substantially aligned with the channels 70 in the second support element 50. Thus, the second support element 50 at the leading edge of the second deck 42 provides an initial suction force on predetermined items diverted onto the divert module 36.

In operation, the suction force from the internal chamber of the second support element 50 and from the vacuum plenum 56 of the second deck 42 hold the predetermined items that have been diverted as those items are transported along the second deck 42. The suction force passes through the orifices 62 of the second transport elements 44.

The diverted items are transported on the second transport elements 44 along the second deck 42 on the divert path D until the items reach the downstream end of the suction region 64, shown in FIG. 6. When the portions of the second transport elements 44 holding an item reach the downstream end of the suction region 64, the respective orifices 62 in the transport elements 44 lose fluid communication with the openings 60 and with the vacuum plenum 56 and the suction force is removed. The diverted items subsequently drop off of the second transport element 44 and fall into the receptacle 66.

The item transport system 12 may be arranged to receive items from an upstream processing unit. Where appropriate, the item transport system 12 maintains items on the transport path P for continued downstream processing. However, in cases where items are not suitable for downstream processing, the item transport system 12 may be used to divert those items.

In the example shown in FIG. 1, the item transport system 12 is installed downstream of the insertion area 24. Where the items comprise financial statements, for example, a determination may be made for an item at that stage of processing as to whether the proper statement has been inserted and/or whether the proper inserts have been added and/or whether the item's weight is at an expected level.

The determinations regarding the status of an item are made using input from one or more sensors (e.g., scanners, photocells, scales, encoders, etc.). Determinations of other pass/fail criteria may also be used. The sensor inputs are fed to the controller (not shown). If all of the criteria match the expected parameters, the fluid supply element 46 is not actuated so that the item may be transported using the first transport element 40 along the first deck 38 on the transport path P for continued processing.

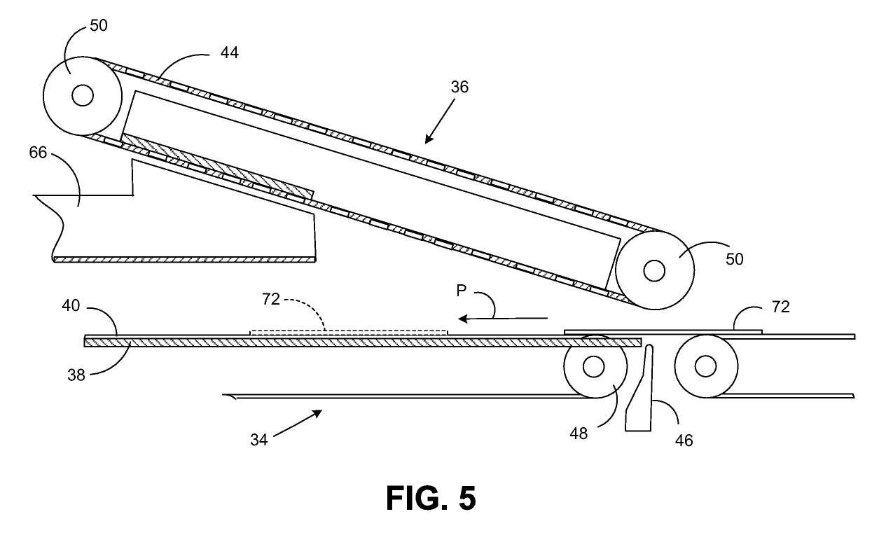

FIG. 5 shows an exemplary item 72 being transported through the item transport system 12 along the transport path P. In a first position, the item 72 is approaching the item transport system 12 from an upstream processing device. Because the fluid supply element 46 does not actuate, the item 72 passes onto the first transport element 40 and is transported along the transport path P. The downstream position of the item 72 is shown in dashed lines in FIG. 5.

If the detected criteria do not match the expected parameters, the item is diverted onto the divert path D for removal from the processing stream. In the example illustrated in FIG. 1, the item transport system 12 is positioned upstream of the printing area 28 where a postage meter applies postage on the item. In that example, if an item has been found to be defective, the item may be diverted prior to the application of postage.

Item transport systems may be provided additionally or alternatively at other locations in the illustrated inserter system. Further, as mentioned above, the item transport system according to the invention may have applicability in sortation systems, as well as other types of item handling systems.

FIG. 6 shows an exemplary predetermined item 74 being transported through the item transport system 12 along the divert path D. In a first position, the predetermined item 74 is approaching the item transport system 12 from an upstream processing device. As the leading edge of the item 74 arrives at a position upstream of the first deck 38, the controller actuates the fluid supply element 46, causing the predetermined item 74 to be diverted onto the second deck 42. During actuation, the fluid supply element 46, which comprises a plurality of nozzles in the illustrated embodiment, emits a burst of pressurized fluid substantially simultaneous with the arrival of the leading edge of the item 74, as shown in FIG. 6. The pressurized fluid impinges on the item 74 and diverts its path of travel onto the second deck 42 where it engages the second transport element 44.

The predetermined item 74 is initially pulled onto the divert path D under the suction force of the upstream second transport element 50. Subsequently, the item 74 is held in place on the moving second transport element 44 by the suction force from the vacuum plenum 56. As discussed above, the suction force is transmitted from the vacuum plenum 56, through the openings 60 in the second deck 42, through the respective orifices 62 in the second transport element 44 to the predetermined item 74. The item 74 is held against the moving second transport element 44 until the orifices 62 communicating the suction force to the item 74 reach the downstream end of the suction region 64. As those orifices pass the downstream end of the suction region 64, the suction force is removed and the item 74 drops off the second transport element 44 and falls into the receptacle 66. The downstream positions of the predetermined item 74 are shown in dashed lines in FIG. 6.

It will be apparent to those skilled in the art that various modifications and variations can be made to the structure and methodology described herein. Thus, it should be understood that the invention is not limited to the examples discussed in the specification. Rather, the present invention is intended to cover modifications and variations.

What is claimed is:

1. An item transport system, comprising:
a first transport, comprising:
a first deck for supporting items; and
a first transport element for transporting the items along the first deck on a transport path; and
a divert module for diverting predetermined items, comprising:
a second deck for supporting the predetermined items;
a second transport element for transporting the predetermined items along the second deck on a divert path; and
a fluid supply element selectively actuable to direct a fluid onto at least a leading edge of the predetermined items to divert the predetermined items onto the second deck.

2. The system of claim 1, further comprising:
a plurality of first support elements rotatably supporting the first transport element;
a plurality of second support elements rotatably supporting the second transport element; and
a drive element for driving at least one of the first support elements and at least one of the second support elements.

3. The system of claim 1, wherein the fluid supply element is disposed upstream of the first transport.

4. The system of claim 1, wherein a leading edge of the second deck is disposed upstream of the fluid supply element.

5. The system of claim 1, wherein the fluid comprises air.

6. The system of claim 1, wherein the fluid supply element comprises a nozzle for directing the fluid.

7. The system of claim 6, wherein the fluid supply element comprises a plurality of nozzles arranged in a direction substantially perpendicular to the divert path.

8. The system of claim 1, wherein the divert module further comprises:
a vacuum plenum proximate to the second deck;
an opening in the second deck in fluid communication with the vacuum plenum; and
a plurality of orifices in the second transport element, wherein each orifice is in fluid communication with the opening when adjacent to the opening.

9. The system of claim 8, wherein the opening defines a suction region extending over a portion of the second deck.

10. The system of claim 8, further comprising a receptacle for receiving the predetermined items from the second transport element.

11. The system of claim 10, wherein the receptacle is disposed at a downstream end of the suction region.

12. The system of claim 1, wherein the second deck is disposed above the first deck.

13. A method of transporting items, comprising:
transporting the items on a first transport, comprising:
supporting the items on a first deck; and
transporting the items with a first transport element along the first deck on a transport path; and
diverting predetermined items on a divert module, comprising:
selectively actuating a fluid supply element to direct a fluid onto at least a leading edge of the predetermined items to divert the predetermined items onto a second deck;
supporting the predetermined items on the second deck; and
transporting the predetermined items with a second transport element along the second deck on a divert path.

14. The method of claim 13, further comprising:
rotatably supporting the first transport element with a plurality of first support elements;
rotatably supporting the second transport element with a plurality of second support elements; and
driving at least one of the first support elements and at least one of the second support elements with a drive element.

15. The method of claim 13, wherein the fluid supply element is disposed upstream of the first transport.

16. The method of claim 13, wherein a leading edge of the second deck is disposed upstream of the fluid supply element.

17. The method of claim 13, wherein the fluid comprises air.

18. The method of claim 13, wherein the fluid supply element comprises a plurality of nozzles arranged in a direction substantially perpendicular to the divert path.

19. The method of claim 13, wherein the divert module comprises:
a vacuum plenum proximate to the second deck;
an opening in the second deck in fluid communication with the vacuum plenum; and
a plurality of orifices in the second transport element, wherein each orifice is in fluid communication with the opening when adjacent to the opening.

20. The method of claim 19, wherein the opening defines a suction region extending over a portion of the second deck.

21. The method of claim 19, further comprising receiving the predetermined items from the second transport element in a receptacle disposed at a downstream end of the suction region.

22. An item transport system, comprising:
a first transport, comprising:
a first deck for supporting items;
a first transport element for transporting the items along the first deck on a transport path; and
a plurality of first support elements rotatably supporting the first transport element;
a divert module for diverting predetermined items, comprising:
a second deck for supporting the predetermined items;
a second transport element for transporting the predetermined items along the second deck on a divert path;
a plurality of second support elements rotatably supporting the second transport element; and
a fluid supply element selectively actuable to direct a fluid onto at least a leading edge of the predetermined items to divert the predetermined items onto the second deck; and
a drive element for driving at least one of the first support elements and at least one of the second support elements.

23. The system of claim 22, wherein the fluid supply element comprises a plurality of nozzles arranged in a direction substantially perpendicular to the divert path.

24. The system of claim 22, wherein the divert module further comprises:
a vacuum plenum proximate to the second deck;
an opening in the second deck in fluid communication with the vacuum plenum, the opening defining a suction region; and
a plurality of orifices in the second transport element, wherein each orifice is in fluid communication with the opening when adjacent to the opening.

25. The system of claim 22, further comprising a receptacle disposed at a downstream end of the suction region for receiving the predetermined items from the second transport element.
